(19) United States
(12) Patent Application Publication
(10) Pub. No.: US 2014/0325981 A1
(43) Pub. Date: Nov. 6, 2014

(54) TURBO SUPERCHARGING DEVICE WITH AIR BLEED AND REGENERATION

(71) Applicant: Vianney RABHI, Lyon (FR)

(72) Inventor: Vianney RABHI, Lyon (FR)

(21) Appl. No.: 14/290,160

(22) Filed: May 29, 2014

Related U.S. Application Data
(60) Provisional application No. 61/806,463, filed on Mar. 29, 2013.
(60) Provisional application No. 61/826,086, filed on May 22, 2013.
(60) Provisional application No. 61/827,196, filed on May 24, 2013.

(30) Foreign Application Priority Data
Mar. 29, 2013 (FR) 1352873
May 21, 2013 (FR) 1354546

(51) Int. Cl. F02M 25/07; F02B 37/16

(52) U.S. Cl. CPC F02M 25/0726; F02M 25/077; F02B 37/164
USPC 60/600; 60/604

(57) ABSTRACT

The inventive turbo supercharging device with air bleed and regeneration (1) for an alternating internal combustion heat engine (2) includes a regenerating exchanger (31) in which the exhaust gases expelled by the engine (2) circulate, the latter transferring their heat to other gases expelled by a centrifugal power compressor (21) before the latter are expanded by a power turbine (27) that rotates the compressor (21), then are cooled in the regenerating exchanger (31) while transferring their heat to the gases expelled by the compressor (21).

### BACKGROUND

1. Summary of the Invention

The present invention relates to a turbo supercharging device with air bleed and regeneration for an alternating internal combustion heat engine.

2. Description of the Related Art

Supercharging using a turbocharger and/or displacement compressor is a key strategy that makes it possible—under certain usage conditions—to reduce the fuel consumption of alternating internal combustion engines propelling motor vehicles. In particular, said supercharging makes it possible to reduce the displacement of said engines at iso-performance, so as to reduce pumping losses and heat losses, and sometimes friction losses. This displacement reduction is commonly referred to as “downsizing”.

It will be noted that downsizing by supercharging is quasi-systematically applied to motor vehicle diesel engines, but more marginally to spark ignition engines, commonly called “gasoline engines”. This is in particular explained by the fact that reducing the displacement of gasoline engines increases the load thereof, which favors spontaneous self-ignition of the gaseous mixture introduced into their cylinder(s). That self-ignition is undesirable, since it produces pinking, which can lead to damage, or even destruction of said gasoline engines. In the case of diesel engines, however, said self-ignition is on the contrary desirable.

Pinking reduces the interest of applying downsizing to motor vehicle gasoline engines. In fact, to avoid it, it is necessary to set the displacement ratio of said engines at a relatively low value. Furthermore, it is necessary to delay their ignition point when they work under high loads. These two factors downgrade the output of downsized gasoline engines both when they are used with low loads due to their low displacement ratio, and when they are used at high loads, particularly under strong supercharging, still due to their low displacement ratio, but also due to their delayed ignition point.

Diesel engines are not affected by these output deterioration factors, such that applying a high downsizing rate to them by supercharging greatly reduces their fuel consumption irrespective of the usage conditions of the vehicle they equip. Thus, while the Actual Specific Consumption of downsized gasoline engines decreases drastically in their high-load operating zones, that of downsized diesel engines, on the contrary, decreases. This is one of the key factors in the commercial success of supercharged diesel engines, since motor vehicles equipped with them have a low actual kilometric consumption, irrespective of the usage made of those vehicles.

For all that, despite the drawbacks described above, gasoline engines downsized by supercharging have a reduced fuel consumption on a regulated driving cycle relative to natural suction gasoline engines offering equivalent performance in terms of brilliance and power. It will be noted that the drawbacks described above are considerably lessened if said gasoline engines have a variable compression rate, similar to the engine known from international patents WO98/51911, WO00/31377, WO03/008783, which belong to the applicant and which describe different mechanical devices for a variable compression ratio engine.

The most cost-effective, efficient, and consequently widespread method of supercharging an alternating internal combustion gasoline or diesel engine is the turbocharger, which comprises a turbine placed at the exhaust of said engine that rotates a centrifugal compressor positioned at the intake of said engine. The turbochargers differ from so-called “displacement” compressors—regardless of type—in that their compressor is driven not by the crankshaft of the alternating internal combustion engine via a mechanical transmission, but by their turbine, through which the exhaust gases from the engine expand to produce the necessary mechanical work.

Thus, the turbochargers recover part of the heat energy available in the exhaust gases of the engines to produce the work necessary to drive their centrifugal compressor. To that end, in the supercharged mode, it is noted that the pressure at the intake of gasoline or diesel engines equipped with a turbocharger remains substantially equal to their exhaust pressure. This is due to the fact that said turbocharger effectively uses the heat energy from the exhaust gases from said engines to supercharge the latter.

The turbocharger applied to the gasoline engine nevertheless has major drawbacks. In fact, the turbine placed at the exhaust causes a strong back pressure that increases the quantity and temperature of the exhaust gases trapped from one cycle to the next in the combustion chamber of said engine. The exhaust gases thus recirculated greatly increase the sensitivity of said engine to pinking, such that it is necessary to further reduce the ignition advance and/or compression rate, to the detriment of its efficiency.

Furthermore, unlike diesel engines, which have a high efficiency, which operate with excess air, and for which the temperature of the exhaust gases does not exceed eight hundred fifty to nine hundred degrees, gasoline engines have a lower output, work near the stoichiometry such that the energy released by the combustion is diluted in a smaller air mass, and expel their exhaust gases at a temperature that may reach one thousand or one thousand fifty degrees, or more. As a result, it is necessary either to make the turbine, its case and the manifold connecting the latter to the gasoline engine with noble and expensive materials, or, concomitantly and beyond a certain load, to cool the exhaust system of said engine to protect the various members thereof by over-injecting fuel into the combustion chamber of said engine, beyond the stoichiometry. The latter strategy drastically increases the fuel consumption and polluting emissions of motor vehicles whose gasoline engines are turbo supercharged, particularly when said engine is used under high loads. Unfortunately, the latter strategy is primarily selected by motor vehicle builders due to its low cost.

The drawbacks described above are the primary obstacles to downsizing motor vehicle gasoline engines, since the gas mileage that they cause on a regulated driving cycle such as the “New European Driving Cycle” (NEDC) can be abnormally lower than that actually achieved on average by end users, since under actual driving conditions, gasoline engines ordinarily have a higher load than on the NEDC. This deviation results in dissatisfaction among said users, who feel deceived by the advantageous gas mileage figures announced for their vehicle by the motor vehicle builder who sold them the vehicle, whereas it is practically impossible for them to reproduce those gas mileage levels under actual driving conditions.

It will be noted that mechanically driven displacement compressors do not resolve this problem; on the contrary, they worsen it. In fact, these compressors being driven by the crankshaft of the heat engine that they supercharge, the latter must produce significant excess power to provide that driving. As a result, at the same rating, to deliver the same efficiency at the output of the crankshaft—i.e., at the same Actual Average Pressure—said engine must operate under a higher Indicated Average Pressure due to the presence of said compressor, the latter increasing the Average Friction Pressure of said engine in significant proportions. Thus, the oversensitivity to pinking produced by the back pressure at the additional exhaust caused by the turbocharger turbine is replaced—in the case of a mechanically driven displacement compressor—by an oversensitivity to pinking with a comparable magnitude caused by the higher Indicated Average Pressure required by the mechanical driving of the displacement compressor, but this time, without the heat lost at the exhaust being partially recovered to drive said compressor. Thus, the use of a mechanical compressor causes an Actual Average Consumption higher than that caused by the use of a turbocharger. Furthermore, mechanically driven displacement compressors are complex, expensive, bulky, and potentially noisy. The only interest of said compressors lies in their quasi-immediate pressure increase, which considerably lessens the response time of the supercharger and allows the driver of the vehicle to obtain the desired torque in a short enough time.

In fact, the response time of the supercharger of a supercharged alternating internal combustion gasoline or diesel heat engine remains a drawback for a motor vehicle equipped with it. If that time is too long, it is necessary to shorten the transmission ratios of the vehicle so that the engine rating increases more quickly and delivers the required power to the wheels of said vehicle in an acceptable amount of time. This is necessary to preserve the driving comfort, brilliance and dynamics of the vehicle. Such short ratios increase the gas mileage of said vehicle.

It will be noted that with the aim of reducing the response time of the turbo supercharging, the diesel engine is also advantageous relative to the gasoline engine. In fact, the diesel engine is not subject to pinking, it operates with excess air, and its thermodynamic output is high. Consequently, its exhaust gases are expelled at a lower temperature, such that it is possible to equip its turbocharger with a variable geometry turbine with strength and temperature limits are lower than those of fixed geometry turbines. That is why such a turbine cannot be manufactured under economically acceptable conditions in the case of gasoline engines, given the high temperature of their exhaust gases resulting both from their combustion at stoichiometry, and their lower output. Furthermore, the output of a variable geometry turbine is lower than that of a fixed geometry turbine. As a result, it causes a higher back pressure at the exhaust to produce the same driving power of the centrifugal compressor. Although that back pressure is acceptable on a diesel engine, where the self-ignition of the fuel at its injector output is promoted, it is difficult on a gasoline engine subject to pinking.

The major efficiency variations of the compressors and turbines constitute another critical point of the turbo supercharging. These variations in particular come from the coupling of the displacement machine, which is an alternating internal combustion gasoline or diesel engine, with the centrifugal machines that are the compressor and the turbocharger turbine. In fact, the major power variations that characterize the use of alternating internal combustion engines in motor vehicles result in major pressure and flow rate variations at the terminals of said compressors and said turbines.

To keep an acceptable efficiency, the turbochargers are thus sized based on an acceptable compromise between the torque at a low rating, the efficiency, the response time and the maximum power of the alternating internal combustion engines equipped therewith.

The main factors that determine the sizing of the turbochargers include the pumping limit of their centrifugal compressor. The pumping occurs in low flow rate operating areas of the centrifugal compressor and can lead to the destruction thereof. The alternating gasoline or diesel engines being displacement machines, when they operate at a low rating, they impose a low flow rate on said compressor, which can enter the pumping zone. This limits the specific torque accessible at a low rating of turbocharged alternating internal combustion engines.

Solutions making it possible to push back the minimum rating of alternating engines where the pumping limit of the centrifugal supercharging compressor has been reached include using two turbochargers instead of only one, the two compressors and the two turbines respectively being placed in series. The first turbocharger is generally large and is called “low-pressure turbocharger”, while the second is smaller and called “high-pressure turbocharger”. In this configuration, each turbocharger works as close as possible to its optimum output while remaining in the rating range of the heat engine that best corresponds to its flow rate characteristics. Thus, the high-pressure turbocharger rather operates at low ratings, since the pumping limit of its compressor is at a very low flow rate. As a result, it allows a high supercharging pressure at very low ratings, with a short response time. The low-pressure turbocharger instead operates at high ratings, since its compressor requires more significant flow rates to remain in its best efficiency range. At intermediate ratings, the low-pressure and high-pressure compressors cooperate, the former pre-compressing the air supercharged by the latter, which gives the staged compressor system thus formed an excellent isoentropic efficiency, particularly when an intercooler is inserted between said two compressors.

Here again, diesel engines stand out over gasoline engines. Indeed, unless they have a variable compression rate or are equipped with a displacement ratio unfavorable to efficiency, gasoline engines cannot claim a specific torque as high as that accessible to diesel engines, particularly at low ratings, where the sensitivity of that type of engine to pinking is maximal. Furthermore, the two turbines mounted in series or in parallel at the exhaust increase the temperature increase time of the pollutant post-treatment catalyst, that drawback having more consequences on the total quantity of pollutants emitted by gasoline engines than by diesel engines.

Regardless of the type of alternating heat engine that it equips, supercharging using two turbochargers remains expensive and bulky. In the current state of the art, it is preferably intended for a limited market consisting of high-performance diesel motor vehicles.

It will be noted that downsizing gasoline engines is most often associated with direct fuel injection (DFI), which in particular makes it possible to reduce the sensitivity of that type of engine to pinking, and to avoid excessive deterioration of the compression ratio and ignition advance. Combined with one or two camshaft phase shifters, DFI further makes it possible to sweep the load of gasoline engines without risking emitting large quantities of hydrocarbons into the exhaust of said engines. The load sweeping primarily makes it possible to reduce the rating where the pumping limit of the centrifugal compressor of the turbocharger is located. In fact, said sweeping makes it possible to make said engines more permeable by simultaneously opening the intake and exhaust valves during a predetermined length of time, such that in the intake phase, a flow rate of cool air higher than that corresponding to their actual displacement is established through said engines. This strategy in particular makes it possible to provide a compressor with larger dimensions, better suited to high powers, while giving the engine equipped therewith a high specific torque at low ratings. It will, however, be noted that load sweeping is only possible over a narrow rating range where the pressure at the intake of the engine remains higher than that at the exhaust.

It will be noted that in motor vehicles, turbochargers are sought whereof the compressor-shaft-turbine rotating assembly has the smallest moment of inertia possible so as to minimize the response time of the supercharging and the kinetic losses that it causes. Keeping said assembly rotating at a relatively high speed, even without any need for supercharging, is also another strategy, which, however, leads to a significant overconsumption of energy, due to the resulting permanent additional back pressure at the exhaust.

It will also be noted that the turbochargers comprise a centrifugal compressor and a turbine whereof the operation and output are optimal when the gas tunnel that crosses through them flows continuously. For all that, said turbochargers supercharge alternating engines whereof the gas stream circulates in a pulsed manner in their intake and exhaust ducts. This contradiction results in a deteriorated efficiency of said compressor and said turbine because of the instantaneous flow rate variations on the one hand, and the difficulty in recovering the kinetic energy of the gases in the turbine on the other hand.

In this context, so-called “twin-scroll” turbine cases improve the efficiency of the turbocharger turbines by allowing them to best use the dynamic pressure generated by the puffs of exhaust gas expelled from the alternating engines. However, these cases are complex to produce and expensive.

It is to resolve, in large part, the problems described above related to the turbo supercharging of alternating internal combustion engines that the turbo supercharging device with air bleed and regeneration according to the invention provides—according to a first particular embodiment only providing a single turbocharger—that:
The turbocharger turbine no longer generates back pressure at the exhaust, which increases the output of the alternating internal combustion engine equipped therewith because on the one hand, if it is a spark ignition engine, the compression rate of the latter that is admissible under high loads can be increased, as can its ignition advance, and on the other hand, irrespective of said alternating engine, the positive work produced on the crankshaft by the supercharging intake pressure is no longer canceled out by negative work of the same level consumed by said crankshaft to overcome the back pressure at the exhaust;
As a result of the preceding point, under high loads, the same Actual Average Pressure is obtained with a lower air and fuel load, which further reduces the sensitivity of the alternating internal combustion engine to pinking if the latter uses gasoline, and which reduces—whether the engine is a gasoline or diesel engine—the quantity of fuel consumed at the same work produced on the crankshaft of said engine, such that the latter has a reduced Actual Average Consumption;
As a result of the two preceding points, under high loads, part of the heat energy of the exhaust gases is converted into additional mechanical work available at the output of the crankshaft of said gasoline or diesel engine;
For a same Actual Average Pressure, the total work transmitted by the combustion piston of the alternating internal combustion engine to the crankshaft of said engine is reduced, which significantly reduces the friction losses of the latter;
It is no longer necessary to over-enrich the load of supercharged gasoline engines, the temperature of their exhaust gases being significantly reduced relative to the state of the art due to the fact that the turbocharger turbine no longer generates back pressure at the exhaust;
At a same supercharging pressure and flow rate, particularly in the case of gasoline engines, the temperature of the gases that drive the turbocharger turbine is significantly reduced relative to the state of the art, which avoids using noble materials to produce said turbine, as well as its case and ducts, that making it possible to produce a turbine at a low cost, with increased reliability and durability;
The energy available for the turbocharger turbine to drive the centrifugal compressor is particularly high, which in particular makes it possible to increase—under high loads—the recirculated exhaust gas rate in the load introduced into the cylinder(s) of the gasoline engines, and the air/fuel ratio of the load introduced into the cylinder(s) of diesel engines, these increases being favorable to the output of said engines;
A same centrifugal compressor can provide a high intake pressure over the entire rating range of the alternating engine that it supercharges while remaining primarily in its optimal efficiency range on the one hand, and far from its pumping limit on the other hand, such that the same said compressor makes it possible to greatly reduce the displacement and the average usage rating of alternating internal combustion heat engines using strategies respectively referred to as downsizing and downspeeding;
The turbocharger used is larger than that which would be selected according to the state of the art for a same engine and to deliver the same power. The centrifugal compressor and the turbine of said turbocharger thus having larger dimensions, their output is higher;
The ability of variable compression ratio engines to receive high supercharging pressures from the lowest ratings without undergoing pinking is used more advantageously, said engines being able to reduce their displacement ratio at high loads to avoid said pinking, whereas they can increase said ratio at partial loads to deliver the highest possible thermodynamic output.

According to a second embodiment with two turbochargers, the turbo supercharging device with air bleed and regeneration according to the invention provides that:
The response time of the supercharging device is particularly short, in particular owing to the use on the one hand of a take off turbocharger specifically sized to provide the gasoline or diesel engine that it supercharges with a high intake pressure from the lowest ratings, and on the other hand a power turbocharger providing said engine with a high intake pressure at middle and high ratings, said power turbocharger remaining continuously rotating a high rating, even without any supercharging of said engine;
It is no longer necessary to sweep the load of gasoline engines using camshaft phase shifter means and direct gasoline injection to optimize the sizing of the centrifugal supercharging compressors;
The two turbochargers can operate at a low enough temperature to be able to be made from low-cost materials, and have excellent reliability and durability.

Consequently, the turbo supercharging device with air bleed and regeneration according to the invention makes it possible to:
Produce extremely compact alternating heat engines with a high power and specific torque;
Reduce, or even eliminate, the energy handicap of gasoline engines relative to diesel engines and which clearly consists of higher Actual Specific Consumptions at high loads, with the key benefit of competitiveness restored to gasoline engines relative to diesel engines;
As a result of the preceding point, to reduce or even eliminate the disappointment of end users of highly supercharged gasoline engine motor vehicles, who note that under actual driving conditions, the gas mileage of their vehicles is much higher than that announced for that vehicle by the motor vehicle builder who sold it to them;
Reduce fuel consumption and carbon dioxide-related emissions of alternating internal combustion heat engine motor vehicles irrespective of their regulated driving cycle, or under ordinary driving conditions, whatever the latter may be;
Improve the performance and dynamism of motor vehicles without increasing their average consumption under ordinary driving conditions;
Increase the reliability, robustness and durability of the turbo supercharging system for said vehicles.

The turbo supercharging device with air bleed and regeneration according to the invention may be provided in the context of any application, including non-motor vehicle, using a diesel or gasoline alternating internal combustion heat engine whereof ignition is controlled by spark or compression, whether that engine has a fixed or variable compression rate, whether the fuel it consumes is liquid or gaseous, and whether the engine performs a 2-stroke, 4-stroke, or any other number of strokes, cycle.

The other features of the present invention have been described in the description and the secondary claims depending directly or indirectly on the primary claim.

The turbo supercharging device with air bleed and regeneration provided for an alternating internal combustion heat engine comprises at least one combustion cylinder, at least one combustion piston connected to at least one crankshaft, at least one intake air filter comprising an input connected to an intake input of the engine and an output connected to an intake distributor via an intake duct of the heat engine, via an intake distributor input duct and via an intake butterfly valve, said engine also comprising at least one exhaust line that begins with an exhaust manifold extended by an exhaust manifold output duct that includes a pollutant post-treatment catalyst, said line also comprises an exhaust muffler and ending with an exhaust line output, while said engine is controlled by at least one EMS management unit, comprises:
At least one regenerating exchanger that includes at least one regenerating cooling channel in which in particular exhaust gases expelled by the alternating internal combustion engine via the exhaust manifold output duct can circulate, said gases being able to cool in contact with the inner walls of said cooling channel before reaching the exhaust line output, said exchanger also including at least one regenerating heating channel in which other gases can circulate that can heat in contact with the inner walls of said heating channel, while the gases that can circulate in the regenerating cooling channel can transfer their heat to the other gases that can circulate in the regenerating heating channel;
at least one power turbocharger that includes at least one centrifugal power compressor able to compress the other gases, said compressor including an input at least connected to the intake input of the engine via an intake duct of the power compressor, while it includes an output that can be connected either to the intake distributor via the intake distributor input duct, or to the regenerating heating channel, or to both, via at least one power compressor output duct;
at least one power turbine included by the power turbocharger and that can expand the other gases to rotate the centrifugal power compressor, said turbine including an input connected to the power compressor output duct via the regenerating heating channel, then via an input duct of the power turbine inserted between said channel and said input, while said turbine includes an output directly or indirectly connected to the exhaust line output via an output duct of the power turbine.

The turbo supercharging device with air bleed and regeneration according to the present invention comprises exhaust gases expelled by the alternating internal combustion heat engine via the exhaust manifold output duct that are mixed before being introduced into the regenerating cooling channel at a junction for mixing gases with the other gases expelled by the power turbine via the output duct of the power turbine, the exhaust gases and said other gases circulating together in said cooling channel before reaching the exhaust line output.

The turbo supercharging device with air bleed and regeneration according to the present invention comprises gases, in particular exhaust gases, that circulate in the regenerating cooling channel that move in the approximate opposite direction from that in which the other gases that circulate in the regenerating heating channel move, while a material with a certain thickness for which one of the faces forms all or part of the inner walls of said cooling channel also forms, on its opposite face, all or part of the inner walls of said heating channel, or vice versa.

The turbo supercharging device with air bleed and regeneration according to the present invention comprises an intake distributor input duct that includes a supercharging air cooler.

The turbo supercharging device with air bleed and regeneration according to the present invention comprises a power compressor output duct that includes a power compressor output check valve allowing the gases circulating in said duct to leave the centrifugal power compressor, but not to return to it.

The turbo supercharging device with air bleed and regeneration according to the present invention comprises a power compressor output duct that includes a power compressor output valve that can connect the output of the centrifugal power compressor with the intake duct of the power turbine.

The turbo supercharging device with air bleed and regeneration according to the present invention comprises a power compressor output duct that includes a bleed valve of the power compressor that can connect said output duct with said intake distributor input duct.

The turbo supercharging device with air bleed and regeneration according to the present invention comprises an intake duct of the power compressor and a power compressor output duct that are connected to each other by a bypass duct of the power compressor that can be closed off by a bypass valve of the power compressor.

The turbo supercharging device with air bleed and regeneration according to the present invention comprises a bypass duct of the power compressor that includes a priming centrifugal compressor.

The turbo supercharging device with air bleed and regeneration according to the present invention comprises an intake duct of the power turbine and an output duct of the power turbine that are connected to each other by a discharge duct of the power turbine that can be closed off by a discharge valve of the power turbine.

The turbo supercharging device with air bleed and regeneration according to the present invention comprises a discharge duct of the power turbine that comprises at least one power trimming drive turbine.

The turbo supercharging device with air bleed and regeneration according to the present invention comprises a power compressor output duct and an exhaust manifold output duct that are connected to each other by a supercharging air bleed duct that can be closed off by a supercharging air bleed valve.

The turbo supercharging device with air bleed and regeneration according to the present invention comprises a part of the intake duct of the power turbine that constitutes part of a regenerating pre-exchanger by forming at least one pre-exchanger heating channel in which the other gases can circulate after the latter have been expelled by the centrifugal power compressor, then are heated in contact with the inner walls of the regenerating heating channel, said pre-exchanger also including at least one pre-exchanger cooling channel that forms part of the exhaust manifold output duct and in which the exhaust gases expelled by the alternating internal combustion heat engine can circulate, the latter gases being able to cool in contact with the inner walls of said cooling channel by transferring their heat to the other gases expelled by the centrifugal power compressor.

The turbo supercharging device with air bleed and regeneration according to the present invention comprises a regenerating pre-exchanger and a regenerating exchanger that are alongside one another to jointly form a two-stage exchanger including at least five exchanger orifices.

The turbo supercharging device with air bleed and regeneration according to the present invention comprises part of the power compressor output duct that constitutes part of a regenerating post-exchanger by forming at least one post-exchanger heating channel in which the other gases can circulate after they have been expelled by the centrifugal power compressor and before the latter circulate in the regenerating heating channel, said post-exchanger also including at least one post-exchanger cooling channel that forms part of the output duct of the power turbine and in which said other gases can circulate after the latter have been expelled by the power turbine, said other gases being able to cool in contact with the inner walls of said cooling channel by transferring their heat to said other gases expelled by the centrifugal power compressor.

The turbo supercharging device with air bleed and regeneration according to the present invention comprises a regenerating post-exchanger and a regenerating exchanger that are alongside one another to jointly form a two-stage exchanger including at least six exchanger orifices.

The turbo supercharging device with air bleed and regeneration according to the present invention comprises a power compressor output duct and/or an intake duct of the power turbine that can include a supercharging pressure reservoir.

The turbo supercharging device with air bleed and regeneration according to the present invention comprises an intake duct of the heat engine that comprises at least one takeoff compressor.

The turbo supercharging device with air bleed and regeneration according to the present invention comprises an intake duct of the power compressor that is connected to the intake input of the engine by a direct supply duct of the power compressor that bypasses the takeoff compressor.

The turbo supercharging device with air bleed and regeneration according to the present invention comprises a direct supply duct of the power compressor that includes a direct supply power check valve allowing the gases circulating in said duct to go from the intake input of the engine toward the intake duct of the power compressor, but not the reverse.

The turbo supercharging device with air bleed and regeneration according to the present invention comprises a takeoff compressor that comprises an output that is connected to the intake distributor input duct by a direct blowing duct of the takeoff compressor independent from the direct supply duct of the power compressor.

The turbo supercharging device with air bleed and regeneration according to the present invention comprises a direct blowing duct of the takeoff compressor that includes a direct blowing takeoff check valve allowing the gases circulating in said duct to go from the takeoff compressor toward the intake distributor input duct, but not the reverse.

The turbo supercharging device with air bleed and regeneration according to the present invention comprises a direct blowing duct of the takeoff compressor that is connected to the direct supply duct of the power compressor by an inter-compressor connecting duct that can be closed off by an inter-compressor connecting duct valve.

The turbo supercharging device with air bleed and regeneration according to the present invention comprises a takeoff compressor that can be rotated by at least one takeoff turbine positioned on the exhaust manifold output duct.

The turbo supercharging device with air bleed and regeneration according to the present invention comprises a takeoff compressor that comprises an input and an output connected to each other by a takeoff compressor bypass duct that can be closed off by a takeoff compressor bypass valve.

The turbo supercharging device with air bleed and regeneration according to the present invention comprises a takeoff turbine that comprises an input and an output connected to each other by a takeoff turbine discharge duct that can be closed off by a takeoff turbine discharge valve.

The turbo supercharging device with air bleed and regeneration according to the present invention comprises an input duct of the power compressor and an input duct of the intake distributor that are connected to each other by a direct intake duct that can be closed off by a direct intake valve.

The turbo supercharging device with air bleed and regeneration according to the invention comprises an intake duct of the heat engine and/or an intake duct of the power compressor that is (are) connected to the exhaust line by an exhaust gas recirculation duct that can be closed off by an exhaust gas recirculation valve.

The turbo supercharging device with air bleed and regeneration according to the present invention comprises an exhaust gas recirculation duct that includes a recirculated exhaust gas cooler.

The turbo supercharging device with air bleed and regeneration according to the present invention comprises all or part of the outer and/or inner surface of the power compressor output duct and/or the intake duct of the power compressor and/or the regenerating exchanger and/or the regenerating pre-exchanger and/or the exhaust manifold output duct and/or the exhaust line, which bears a heat screen.

### BRIEF DESCRIPTION OF THE DRAWINGS

The following description, in light of the appended drawings, provided as non-limiting examples, will make it possible to better understand the invention, the features thereof, and the advantages that it may procure:

FIG. 1 illustrates the block diagram of the turbo supercharging device with air bleed and regeneration for an alternating internal combustion heat engine according to the present invention, provided with a power turbocharger as sole supercharging means, the gases expelled at the power turbine output emerging at the output of the exhaust line without passing through the regenerating cooling channel of the regenerating exchanger.

FIG. 2 illustrates the block diagram of the turbo supercharging device with air bleed and regeneration for an alternating internal combustion heat engine according to the present invention provided with a power turbocharger as sole supercharging means, the gases expelled at the output of the power turbine passing through the regenerating cooling channel of the regenerating exchanger via a junction for mixing the gases before emerging at the output of the exhaust line.

FIG. 3 illustrates a block diagram of an alternative of the turbo supercharging device with air bleed and regeneration according to the invention that in particular provides a regenerating pre-exchanger and a direct intake duct.

FIG. 4 illustrates the block diagram of one alternative, particularly suitable for alternating internal combustion engines designed to propel motor vehicles, of the turbo supercharging device with air bleed and regeneration according to the invention, said alternative in particular providing a takeoff turbocharger and a recirculation duct for the exhaust gases.

FIG. 5 illustrates a block diagram of an alternative, suitable for alternating internal combustion engines designed to propel a motor vehicle, of the turbo supercharging device with air bleed and regeneration according to the invention, said alternative in particular providing—aside from a takeoff turbocharger and an exhaust gas recirculation duct—a direct supply duct of the power compressor, a direct blowing duct of the takeoff compressor, an inter-compressor connecting duct and a two-stage exchanger.

FIG. 6 illustrates the block diagram of an alternative of the turbo supercharging device with air bleed and regeneration according to the invention similar to that illustrated in FIG. 5, but which differs from the latter in that it includes a regenerating post-exchanger (70).

### DESCRIPTION OF THE INVENTION

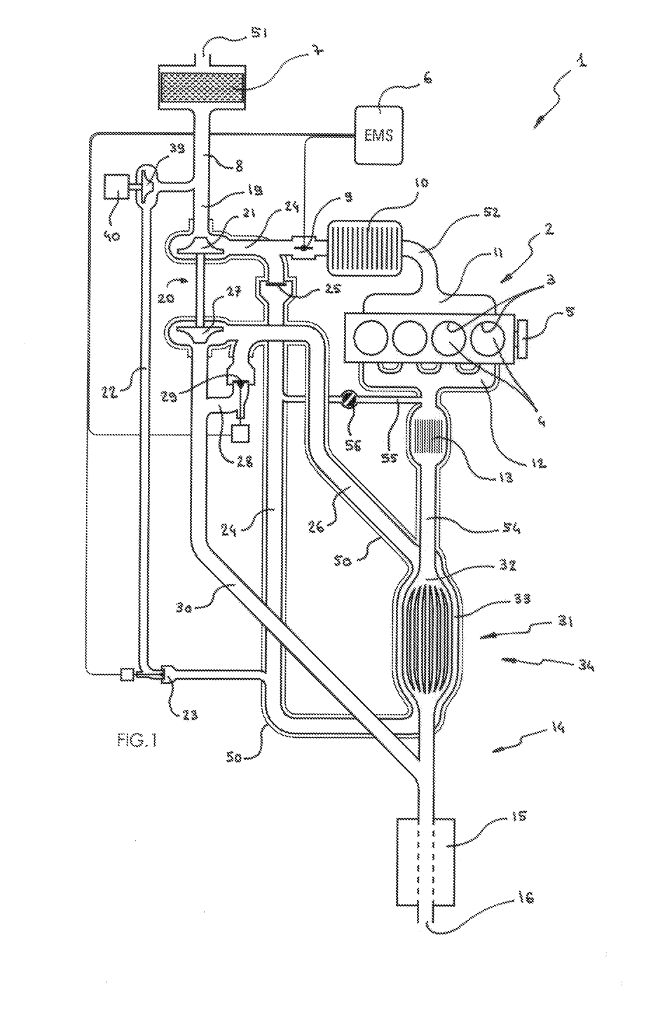

FIGS. 1 to 6 show the turbo supercharging device with air bleed and regeneration 1 for an alternating internal combustion heat engine 2.

The turbo supercharging device with air bleed and regeneration 1 is provided for an alternating internal combustion heat engine 2 that comprises at least one combustion cylinder 3, at least one combustion piston 4 connected to at least one crankshaft 5, at least one intake air filter 7 comprising an input connected to an intake input of the engine 51 and an output connected to an intake distributor 11 via an intake duct of the heat engine 8, via an intake distributor input duct 52 and via an intake butterfly valve 9, said engine 2 also comprising at least one exhaust line 14 that starts with an exhaust manifold 12 extended by an exhaust manifold output duct 54 that includes a pollutant post-treatment catalyst 13, said line 14 also comprising an exhaust muffler 15 and ending with an exhaust line output 16, while said engine 2 is controlled by at least one EMS management unit 6.

FIGS. 1 to 6 show that the turbo supercharging device with air bleed and regeneration 1 includes at least one regenerating exchanger 31 that includes at least one regenerating cooling channel 32 in which exhaust gases expelled by the alternating internal combustion heat engine 2 via the exhaust manifold output duct 54 can in particular circulate, said gases being able to cool in contact with the inner walls of said cooling channel 32 before reaching the exhaust line output 16, said exchanger 31 also including at least one regenerating heating channel 33 in which other gases can circulate that can heat in contact with the inner walls of said heating channel 33, while the gases that can circulate in the regenerating cooling channel 32 can transfer their heat to the other gases that can circulate in the regenerating heating channel 33.

According to one particular embodiment of the supercharging device 1 according to the invention, the regenerating exchanger 31 can be fastened below a motor vehicle that can propel the alternating internal combustion heat engine 2 using rigid or elastic fasteners. In this context, the regenerating cooling channel 32 and/or the regenerating heating channel 33 included by the regenerating exchanger 31 can be directly or indirectly connected to said engine 2 using at least one duct and/or at least one uncoupling flange that reduces the intensity of the movements and vibrations transmitted by said engine 2 to said exchanger 31.

Furthermore, FIGS. 1 to 6 illustrate that the turbo supercharging device with air bleed and regeneration 1 also includes at least one power turbocharger 20 that includes at least one centrifugal power compressor 21 that can compress the other gases, said compressor 21 including an input at least connected to the intake input of the engine 51 or to any other intake via an intake duct of the power compressor 19 while it includes an output that can be connected either to the intake distributor 11 via the intake distributor input duct 52, or to the regenerating reheating channel 33, or to both, via at least one power compressor output duct 24, the centrifugal power compressor 21 being able to the axial or radial, one-, two- or multi-staged, made up of any material more or less resistant to the temperature and/or oxidation and may—generally—be of any type known by those skilled in the art.

The turbo supercharging device with air bleed and regeneration 1 further comprises at least one power turbine 27 included by the power turbocharger 20 and which can expand the other gases after the latter have been compressed by the centrifugal power compressor 21 in order to rotate the centrifugal power compressor 21, said turbine 27 including an input connected to said power compressor output duct 24 via the regenerating reheating channel 33, then via an intake duct of the power turbine 26 inserted between said channel 33 and said input, while said turbine 27 includes an output connected directly or indirectly to the exhaust line 16 or to any other output via an output duct of the power turbine 30.

It will also be noted that the power turbine 27 can be axial or radial, with fixed geometry or variable geometry, while for example being housed in a case provided with blades, the angular orientation of which can be modified by the EMS management unit 6 using a pneumatic, electropneumatic, electric, hydraulic or electrohydraulic actuator. It will be noted that said turbine 27 can also be one-, two- or multi-staged, made up of any material more or less resistant to the temperature and/or oxidation and may—generally—be of any type known by those skilled in the art.

According to one particular embodiment of the supercharging device 1 according to the invention, the power turbine 27 can be connected to a motor-generator that can produce electricity when it is rotated by said turbine 27 or that can launch the rotation of the latter when it is subject to the passage of an electric current.

According to another particular embodiment of the supercharging device 1 according to the invention, the intake duct of the power turbine 26 can include a combustion chamber that comprises a device for supplying fuel such as an injector, and an ignition device that can for example be a spark plug. Said combustion chamber serves to overheat the other gases so that the latter provide more energy to the power turbine 27, said other gases serving as oxidizer in the combustion process done in said chamber.

Alternatively, the aforementioned combustion chamber may be replaced by an explosion chamber in which an air-fuel mixture accumulates, said air being made up of other gases while said fuel is brought in by a fuel supply device such as an injector, said mixture next being ignited by an ignition device that may for example be a spark plug. As an improvement, said explosion chamber may cooperate with at least one check valve positioned upstream from said chamber relative to the flow of the other gases in the intake duct of the power turbine 26 so that all of the thrust caused by the combustion of said mixture is used to drive the power turbine 27.

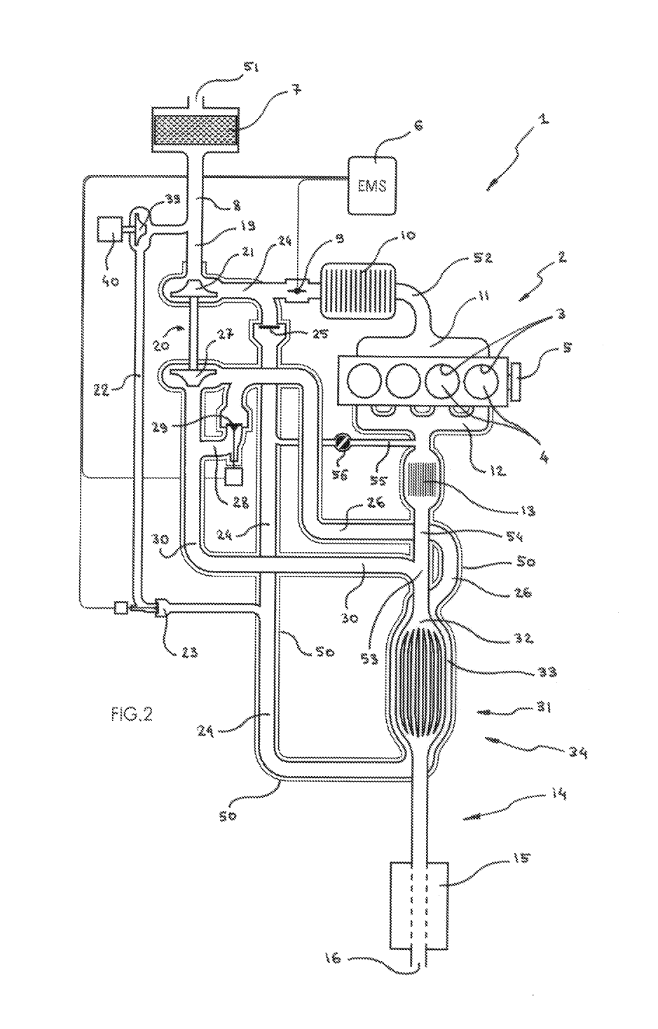

As illustrated in FIGS. 2 to 5, the turbo supercharging device with air bleed and regeneration 1 provides that the exhaust gases expelled by the alternating internal combustion heat engine 2 via the exhaust manifold output duct 54 are mixed before being introduced into the regenerating cooling channel 32 at a junction for mixing gases 53 with the other gases expelled by the power turbine 27 via the output duct of the power turbine 30, the exhaust gases and said other gases circulating together in said cooling chamber 32 before reaching the exhaust line output 16.

According to the turbo supercharging device with air bleed and regeneration 1 according to the invention, the gases, in particular exhaust gases, that circulate in the regenerating cooling channel 32 can move in the approximate opposite direction from that in which the other gases move that circulate in the regenerating heating channel 33, while a material with a certain thickness whereof one of the faces forms all or part of the inner walls of said cooling channel 32 also forms, on its opposite face, all or part of the inner walls of said heating channel 33, or vice versa. It will be noted that the counter-current regenerating exchanger 34 that results from this arrangement may be made by stacking sheets fastened to each other, by assembling tubes, or by any other design and manufacturing method known by those skilled in the art and applicable to heat exchangers.

Consequently, the turbo supercharging device with air bleed and regeneration 1 according to the invention provides that the intake distributor input duct 52 can include a supercharging air cooler 10 that cools the air compressed by the centrifugal power compressor 21 before said air reaches the intake distributor 11, said cooler 10 for example being able to be of the air/air or air/water type. In the latter case, said water can come from a cooling circuit that may be included by the alternating internal combustion heat engine 2, or an independent cold water circuit.

It will be noted in FIGS. 1 to 3 that the power compressor output duct 24 can include a power compressor output check valve 25 allowing the gases circulating in said duct 24 to leave the centrifugal power compressor 21, but not to return thereto.

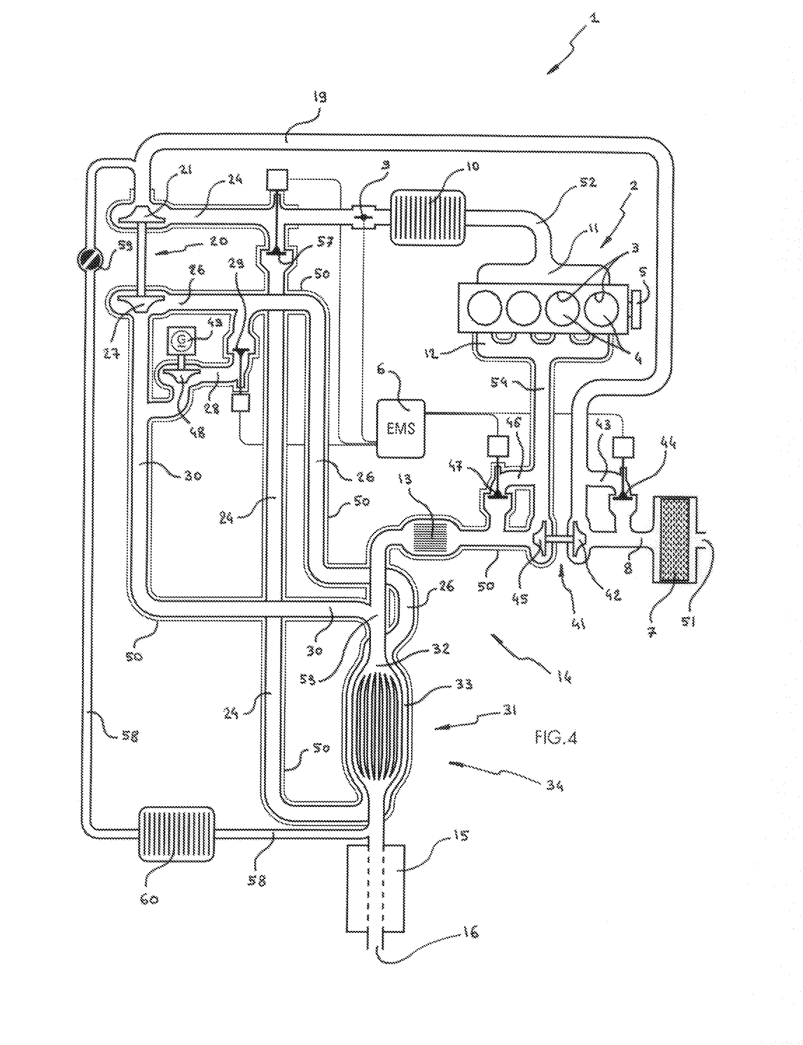

In an alternative illustrated in FIGS. 4 to 6, the power compressor output duct 24 can include a power compressor output valve 57 that can connect the output of the centrifugal power compressor 21 with the intake duct of the power turbine 26, or which can close off said output duct 24. Said valve 57 may be kept open, closed or partially open so as to allow or not allow the passage of gas in said output duct 24, said valve 57 being able to be made up of a flap, sliding gate, plug or any other means known by those skilled in the art making it possible to close off or open a duct, and said valve 57 being able to be controlled to open or close by the EMS management unit 6, in particular using a pneumatic, electropneumatic, electric, hydraulic or electrohydraulic actuator.

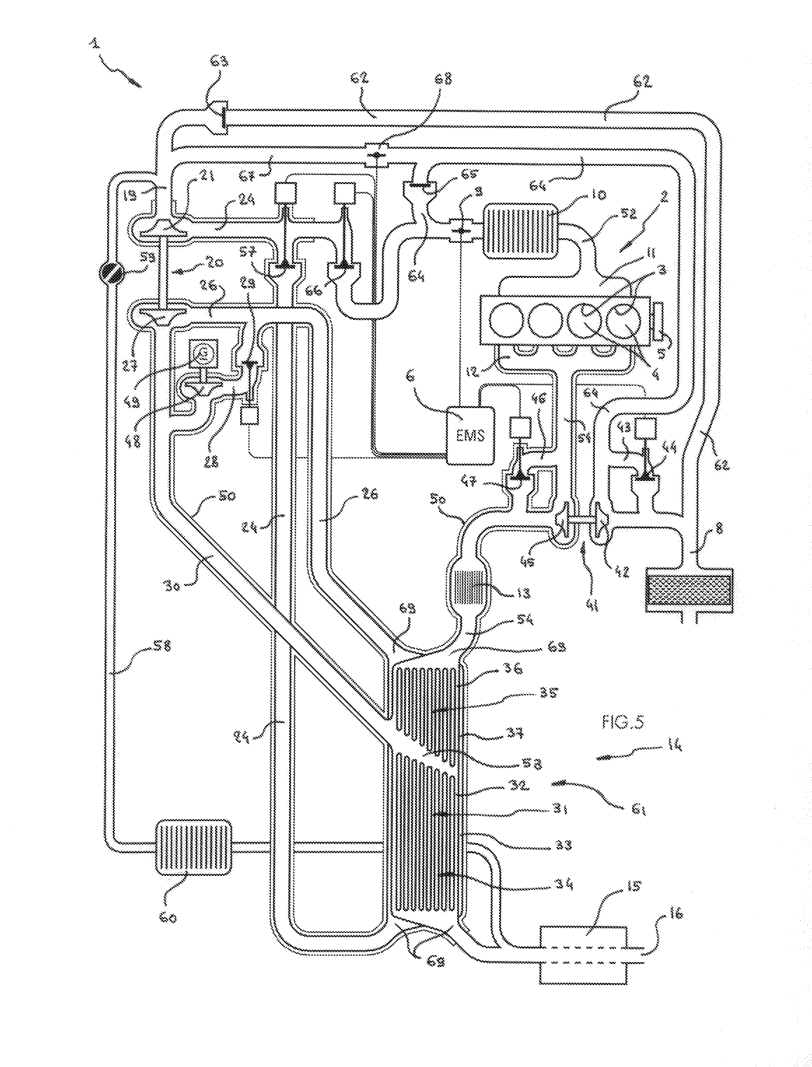

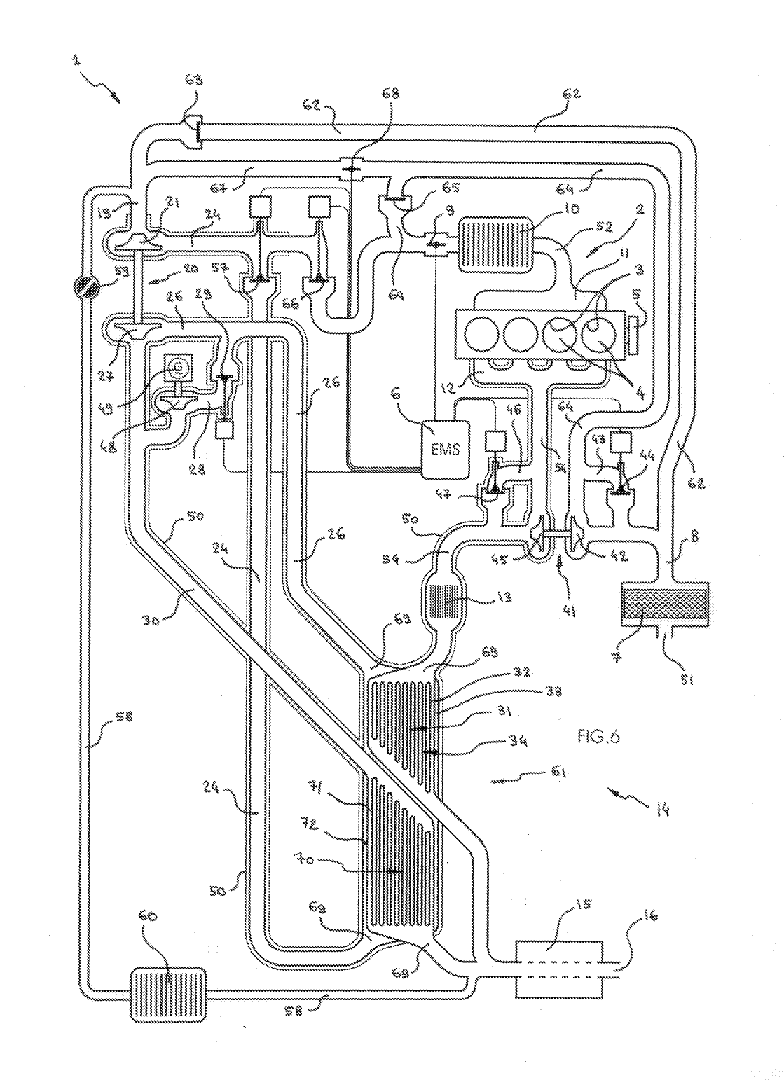

FIGS. 5 and 6 show that the power compressor output duct 24 can also include a bleed valve of the power compressor 66 that can connect said output duct 24 with said intake distributor input duct 52. Similarly to the power compressor output valve 57, the bleed valve of the power compressor 66 can be made up of a flap, sliding gate, plug or any other means known by those skilled in the art making it possible to close off or open a duct, while said valve 66 can also be controlled to open or close by the EMS management unit 6, in particular using a pneumatic, electropneumatic, electric, hydraulic or electrohydraulic actuator.

According to one alternative of the turbo supercharging device with air bleed and regeneration 1, the intake duct of the power compressor 19 and the power compressor output duct 24 can be connected to each other by a bypass duct of the power compressor 22 that can be closed off by a bypass valve of the power compressor 23, which can be kept open, closed or partially open so as to allow or not allow the passage of gas in said bypass duct 22, said valve 23 being able to be made up of a flap, sliding gate, plug or any other means known by those skilled in the art making it possible to close off or open a duct, said valve 23 being able to be controlled to open or close by the EMS management unit 6, in particular using a pneumatic, electropneumatic, electric, hydraulic or electrohydraulic actuator.

As another alternative of the turbo supercharging device with air bleed and regeneration 1 illustrated in FIGS. 1 and 2, the bypass duct of the power compressor 22 can include a priming centrifugal compressor 39 that can suction gases in the intake duct of the power compressor 19 and/or the intake duct of the heat engine 8 to discharge them into the power compressor output duct 24 so as to start the rotation of the centrifugal power compressor 21 and the power turbine 27 included by the power turbocharger 20, for example when the alternating internal combustion heat engine 2 is started up.

To that end, a priming compressor electric motor 40 can be mechanically connected to the centrifugal priming compressor 39, the EMS management unit 6 being able to power on said electric motor 40 such that the latter sets said compressor 39 in rotation.

According to one particular embodiment of the supercharging device 1 according to the invention, the priming compressor electric motor 40 can be replaced by a pneumatic or hydraulic turbine, by a mechanical transmission connected to the crankshaft 5, or by any other driving means.

The turbo supercharging device with air bleed and regeneration 1 further provides that the intake duct of the power turbine 26 and the output duct of the power turbine 30 can be connected to each other by a discharge duct of the power turbine 28 that can be closed off by a discharge valve of the power turbine 29 that can be kept open, closed or partially open so as to allow or not allow the passage of the gas in said discharge duct 28, said valve 29 being able to be made up of a flap, sliding gate, plug or any other means known by those skilled in the art making it possible to close off or open a duct, and said valve 29 being able to be controlled to open or close by the EMS management unit 6, in particular using a pneumatic, electropneumatic, electric, hydraulic or electrohydraulic actuator.

As shown by FIGS. 4 to 6, the turbo supercharging device with air bleed and regeneration 1 also provides that the discharge duct of the power turbine 28 can comprise at least one power trimming drive turbine 48 that can rotate a power trimming electricity generator 49, said turbine 28 being able to be of the single- or multi-staged type, and displacement or centrifugal type, while said electricity generator 49 can produce direct or alternating current, at a high or low pressure.

Alternatively, the power trimming drive turbine 48 can be directly or indirectly connected by mechanical means to the crankshaft 5 to assist the alternating internal combustion heat engine 2.

FIGS. 1 and 2 show that, according to one alternative of the turbo supercharging device with air bleed and regeneration 1, the power compressor output duct 24 and the exhaust manifold output duct 54 can be connected to each other by a supercharging air bleed duct 55 that can be closed off by a supercharging air bleed valve 56 that can be kept open, closed or partially open so as to allow or not allow the passage of gas in said bleed duct 55, said valve 56 being able to be formed by a flap, sliding gate, plug or any other means known by those skilled in the art making it possible to close or open a duct, and said valve 56 being able to be controlled to open or close by the EMS management unit 6, in particular using a pneumatic, electropneumatic, electric, hydraulic or electrohydraulic actuator.

It will be noted that—according to one particular embodiment of the supercharging device 1 according to the invention—the supercharging air bleed duct 55 may emerge in the exhaust manifold output duct 54 upstream from the pollutant post-treatment catalyst 13 such that the exhaust gases expelled by the alternating internal combustion heat engine 2 are mixed with the gases leaving the supercharging air bleed duct 55 before they pass inside said catalyst 13.

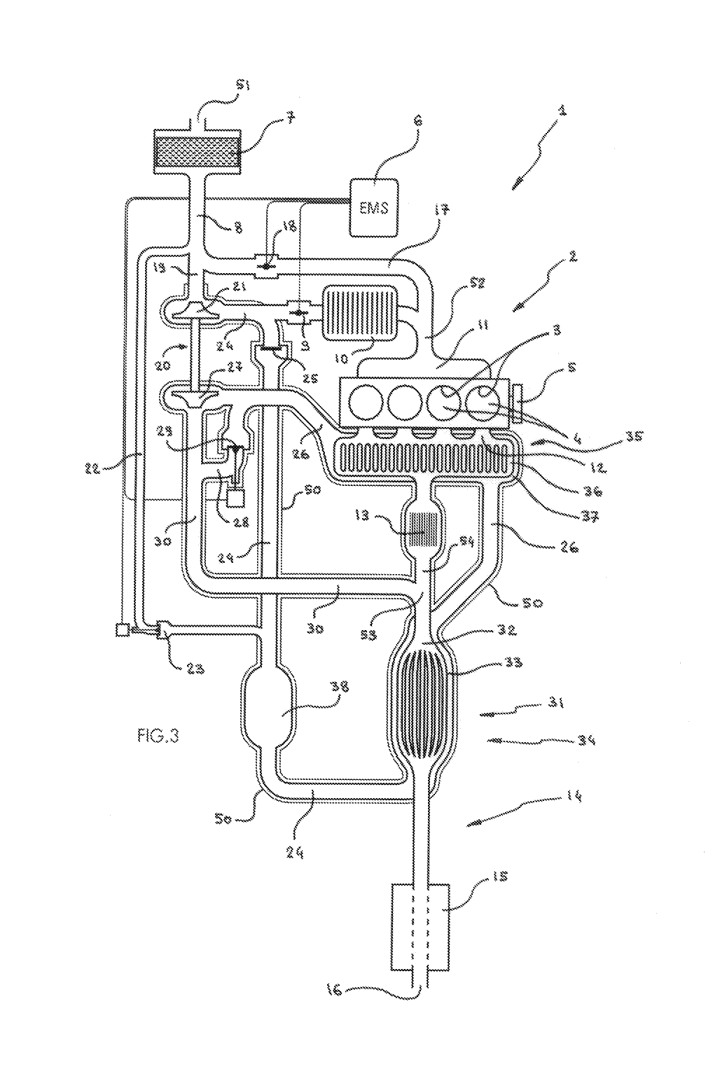

As shown by FIGS. 3 and 5, part of the intake duct of the power turbine 26 can make up part of a regenerating pre-exchanger 35 while forming at least one pre-exchanger heating channel 37 in which the other gases can circulate after the latter have been expelled by the centrifugal power compressor 21, then heated in contact with the inner walls of the heating regenerating channel 33, said pre-exchanger 35 also including at least one pre-exchanger cooling channel 36 formed by part of the exhaust manifold output duct 54 and in which the exhaust gases expelled by the alternating internal combustion heat engine 2 can circulate, the latter gases being able to cool in contact with the inner walls of said cooling channel 36 while transferring their heat to the other gases expelled by the centrifugal power compressor 21.

According to one particular embodiment of the supercharging device 1 according to the invention, the other gases that circulate in the pre-exchanger heating channel 37 can move in the approximate opposite direction from that in which the gases that circulate in the pre-exchanger cooling channel 36 move, while a material with a certain thickness whereof one of the faces forms all or part of the inner walls of said heating channel 37 also forms, on its opposite face, all or part of the inner walls of said cooling channel 36, or vice versa. The counter-current regenerating pre-exchanger that results from this arrangement can be made by stacking sheets fastened to each other, by assembling tubes, or by any other design and manufacturing method known by those skilled in the art and applicable to heat exchangers.

FIG. 5 shows that the regenerating pre-exchanger 35 and regenerating exchanger 31 can be alongside one another to jointly form a two-stage exchanger 61 including at least five exchanger orifices 69 respectively and directly or indirectly connected to the power compressor output duct 24, the intake duct of the power turbine 26, the exhaust line output 16, the exhaust manifold 12 and the output duct of the power turbine 30.

It will be noted that advantageously, the two-stage exchanger 61 can be a plate exchanger, each plate being able to be made up of a fine sheet of stainless steel whereof the raised portion is worked so as on the one hand to offer a large heat exchange surface, and on the other hand to promote a non-laminar flow of the gases on the surface of said sheet. It will be noted that according to this configuration, said plates can be gripped between two plenums, the structure of which makes it possible to give the two-stage exchanger 61 the desired rigidity while ensuring the conveyance of the gases between the exchanger orifices 69 and connectors (not shown), on which the different ducts connecting the two-stage exchanger 61 to the members 24, 26, 16, 12, 30 previously listed can be connected.

As illustrated in FIG. 6, part of the power compressor output duct 24 can form part of a regenerating post-exchanger 70 while forming at least one post-exchanger heating channel 72 in which the other gases can circulate after they have been expelled by the centrifugal power compressor 21 and before the latter circulate in the regenerating heating channel 33, said post-exchanger 70 also including at least one post-exchanger cooling channel 71 formed by part of the output duct of the power turbine 30 and in which said other gases can circulate after the latter have been expelled by the power turbine 27, said other gases being able to cool in contact with the inner walls of said cooling channel 71 by transferring their heat to said other gases expelled by the centrifugal power compressor 21.

According to one particular embodiment of the supercharging device 1 according to the invention, the other gases that circulate in the post-exchanger heating channel 72 can move in the approximate opposite direction from that in which the other gases that circulate in the post-exchanger cooling channel 71 move, while a material with a certain thickness whereof one of the faces forms all or part of the inner walls of said heating channel 72 also forms, on its opposite face, all or part of the inner walls of said cooling channel 71, or vice versa. The counter-current regenerating post-exchanger that results from this arrangement can be made by stacking sheets fastened to each other, by assembling tubes, or by any other design and manufacturing method known by those skilled in the art and applicable to heat exchangers.

FIG. 6 illustrates that the regenerating post-exchanger 70 and regenerating exchanger 31 can be alongside one another to jointly form a two-stage exchanger 61 including at least six exchanger orifices 69 respectively and directly or indirectly connected to the power compressor output duct 24, the intake duct of the power turbine 26, the exhaust line output 16, the exhaust manifold 12 and the output duct of the power turbine 30.

It will be noted that advantageously, said two-stage exchanger 61 can be a plate exchanger, each plate being able to be made up of a fine sheet of stainless steel whereof the raised portion is worked so as on the one hand to offer a large heat exchange surface, and on the other hand to promote a non-laminar flow of the gases on the surface of said sheet. It will be noted that according to this configuration, said plates can be gripped between two plenums, the structure of which makes it possible to give the two-stage exchanger 61 the desired rigidity while ensuring the conveyance of the gases between the exchanger orifices 69 and connectors (not shown), on which the different ducts connecting the two-stage exchanger 61 to the members 24, 26, 16, 12, 30 previously listed can be connected.

FIG. 3 illustrates that the turbo supercharging device with air bleed and regeneration 1 comprises, according to one particular embodiment, a power compressor output duct 24 and/or an intake duct of the power turbine 26 that can include a supercharging pressure reservoir 38.

Furthermore, as illustrated by FIGS. 4 to 6, the turbo supercharging device with air bleed and regeneration 1 can include an intake duct of the heat engine 8 that comprises at least one takeoff compressor 42 that can suction atmospheric air or a gas in particular via the intake input of the engine 51, while said compressor 42 can be centrifugal, displacement, with blades, with piston, with paddles, scroll, or of any other type known by those skilled in the art, it can be rotated by any electric, pneumatic, hydraulic or mechanical means, and its output can include a supercharging air cooler or be directly or indirectly connected to the latter.

FIGS. 5 and 6 show that the intake duct of the power compressor 19 can be connected to the intake duct of the engine 51 by a direct supply duct of the power compressor 62 that bypasses the takeoff compressor 42.

It will also be noted that the direct supply duct of the power compressor 62 can include a direct power supply check valve 63 allowing the gases circulating in said duct to go from the intake input of the engine 51 toward the intake duct of the power compressor 19, but not the reverse.

In the particular context illustrated by FIGS. 5 and 6, it will be noted that the takeoff compressor 42 can advantageously comprise an output that is connected to the intake distributor input duct 52 by a direct blowing duct of the takeoff compressor 64 independent from the direct supply duct of the power compressor 62.

The direct blowing duct of the takeoff compressor 64 can, in this case, include a direct takeoff blowing check valve 65 allowing the gases circulating in said duct 64 to go from the takeoff compressor 42 to the intake distributor input duct 52, but not the reverse.

FIGS. 5 and 6 also show that the direct blowing duct of the takeoff compressor 64 can be connected to the direct power supply duct of the power compressor 62 by an inter-compressor connecting duct 67 that can be closed off by an inter-compressor connecting duct valve 68.

It will be noted in FIGS. 4 to 6 that the takeoff compressor 42 can be rotated by at least one takeoff turbine 45 positioned on the exhaust manifold output duct 54, said compressor 42 being able to be centrifugal so as to form a takeoff turbocharger 41 with said turbine 45, and be axial or radial, one-, two- or multi-staged, made up of any material more or less resistant to the temperature and/or oxidation and—generally—be of any type known by those skilled in the art, while the same is true for the takeoff turbine 45, which can further be housed in a case provided with blades, the angular orientation of which can be modified by the EMS management unit 6 using a pneumatic, electropneumatic, electric, hydraulic or electrohydraulic actuator.

As an alternative described in FIGS. 4 to 6, the turbo supercharging device with air bleed and regeneration 1 provides that the takeoff compressor 42 can comprise an input and an output connected to each other by a takeoff compressor bypass duct 43 that can be closed off by a takeoff compressor bypass valve 44 that can be kept open, closed or partially open so as to allow or not allow the passage of atmospheric air or a gas in said bypass duct 43, said valve 44 being able to be made up of a flap, sliding gate, plug or any other means known by those skilled in the art making it possible to close off or open a duct, and said valve 44 being able to be controlled to open or close by the EMS management unit 6, in particular using a pneumatic, electropneumatic, electric, hydraulic or electrohydraulic actuator.

Similarly, the takeoff turbine 45 can comprise an input and output connected to each other by a takeoff turbine discharge duct 46 that can be closed off by a takeoff turbine discharge valve 47 that can be kept open, closed or partially open so as to allow or not allow the passage of atmospheric air or a gas in said discharge duct 46, said valve 47 being able to be made up of a flap, sliding gate, plug or any other means known by those skilled in the art making it possible to close off or open a duct, and said valve 47 being able to be controlled to open or close by the EMS management unit 6, in particular using a pneumatic, electropneumatic, electric, hydraulic or electrohydraulic actuator.

FIG. 3 shows that the intake duct of the power compressor 19 and the intake distributor input duct 52 can be connected to each other by a direct intake duct 17 that can be closed off by a direct intake valve 18 that can be kept open, closed or partially open so as to allow or not allow the passage of gas in said direct intake duct 17, said valve 18 being able to be made up of a flap, sliding gate, plug or any other means known by those skilled in the art making it possible to close off or open a duct, and said valve 18 being able to be controlled to open or close by the EMS management unit 6, in particular using a pneumatic, electropneumatic, electric, hydraulic or electrohydraulic actuator.

The turbo supercharging device with air bleed and regeneration 1 can also comprise, as illustrated in FIGS. 4 to 6, an intake duct of the heat engine 8 and/or an intake duct of the power compressor 19 that is (are) connected with the exhaust line 14 by an exhaust gas recirculation duct 58 that can be closed off by an exhaust gas recirculation valve 59, the latter being able to be kept open, closed or partially open so as to allow or not allow the passage of gas in said recirculation duct 58, said valve 59 being able to be made up of a flap, sliding gate, plug or any other means known by those skilled in the art making it possible to close off or open a duct, and said valve 59 being able to be controlled to open or close by the EMS management unit 6, in particular using a pneumatic, electropneumatic, electric, hydraulic or electrohydraulic actuator.

It will also be noted in FIGS. 4 to 6 that the exhaust gas recirculation duct 58 can include a recirculated exhaust gas cooler 60 that cools exhaust gases conveyed by said duct 58 from the exhaust line 14 to the intake duct of the heat engine 8 and/or to the intake duct of the power compressor 19 before said gases reach said duct(s), said cooler 60 for example being able to be of the air/air or air/water type. In the latter case, said water can come from a cooling circuit that may be included by the alternating internal combustion heat engine 2, or an independent cold water circuit.

The turbo supercharging device with air bleed and regeneration 1 further provides that all or part of the outer and/or inner surface of the power compressor output duct 24 and/or the intake duct of the power turbine 26 and/or the regenerating exchanger 31 and/or the regenerating pre-exchanger 35 and/or the exhaust manifold 12 and/or the exhaust manifold output duct 54 and/or the exhaust line 14 can be covered with a heat screen 50 that can be an inner and/or outer heat insulating material and/or structure that retains the heat from the gases circulating inside the components 24, 26, 31, 35, 54, 14 listed above. Said heat insulating material and/or structure can be made up of rock wool, a double or multiple metallic or non-metallic thermal skin(s) kept at a distance from said components 24, 26, 31, 35, 54, 14 by heat insulating studs, or any other arrangement known by those skilled in the art and that makes it possible to retain heat. It will also be noted that said heat insulating material and/or structure can apply to any other component member of the supercharging device 1 according to the invention.

### Operation of the Invention:

From the preceding description and relative to FIGS. 1 to 6, the operation of the turbo supercharging device with air bleed and regeneration 1 for an alternating internal combustion heat engine 2 according to the present invention is understood.

In order to illustrate the operation of said device 1, we have primarily chosen the configuration shown in FIG. 5, which has been applied to an alternating internal combustion heat engine 2 responsible for propelling a motor vehicle (not shown).

The alternating internal combustion heat engine 2, which is stopped and cold, is started by the driver of said motor vehicle. Said motor 2 then sucks atmospheric air through the intake input of the engine 51, then expels exhaust gas through the exhaust line output 16. Said driver next decides to operate said motor vehicle at a low speed, and therefore at low power. To meet this need, the EMS management unit 6 keeps the intake butterfly valve 9 partially closed, such that the alternating internal combustion heat engine 2 operates under a low load, while it travels at low speed.

Simultaneously, the takeoff turbine discharge valve 47 shown in FIG. 5 is kept open, such that the hot exhaust gases expelled from said engine 2 heat the pollutant post-treatment catalyst 13 as quickly as possible. The entire exhaust line 14 then increases in temperature, including the two-stage exchanger 61, which includes the counter-current regenerating exchanger 34 and the regenerating pre-exchanger 35, while the takeoff compressor bypass valve 44 is kept open.

Thus far, the inter-compressor connecting duct valve 68 has been kept open, while the power compressor output 57 and the bleed valve of the power compressor 66 have both been kept closed by the EMS management unit 6.

If, in response to random factors during his journey, the driver requests a high torque from the alternating internal combustion heat engine 2 by pressing the accelerator pedal down deeply in said motor vehicle, then the EMS management unit 6 fully opens the intake butterfly valve 9, closes the takeoff turbine discharge valve 47 and the takeoff compressor bypass valve 44.

This results in fully filling the combustion cylinders 3 of the alternating internal combustion heat engine 2, which immediately delivers more power on the crankshaft 5 and gives a higher flow rate, pressure and temperature to the exhaust gases it expels into the exhaust manifold output duct 54 on which the takeoff turbine 45 is positioned.

Said turbine 45 then begins to rotate quickly and drives the takeoff compressor 42, which causes the pressure of the atmospheric air circulating in the direct blowing duct of the takeoff compressor 64 to increase. The atmospheric air leaving the takeoff compressor 42 is admitted by the alternating internal combustion heat engine 2 via the direct blowing duct of the takeoff compressor 64, the supercharging air cooler 10, the intake distributor input duct 52 that comprises the intake butterfly valve 9, and lastly the intake distributor 11, respectively, such that the torque from said engine 2 increases quickly, as does the energy that it provides to the takeoff turbine 45 via its exhaust gases.

It will be noted that at this stage, the direct power supply check valve 63 included by the direct supply duct of the power compressor 62 is kept closed by the pressure prevailing downstream from said valve 63.

The alternating internal combustion heat engine 2 having reached a sufficient specific torque, the EMS management unit 6 partially opens the power compressor output valve 57 to allow part of the atmospheric air flow rate leaving the takeoff compressor 42 to pass through the centrifugal power compressor 21, which begins to rotate under the effect of the passage of said atmospheric air, said flow rate having previously passed in the direct blowing duct of the takeoff compressor 64, then through the inter-compressor connection duct 67 and the intake duct of the power compressor 19, respectively.

It will be noted at this stage that the alternating internal combustion engine 2 rotating slowly, but having to deliver a high torque, the takeoff turbocharger 41 must deliver—using the takeoff compressor 42—a high pressure in the intake distributor 11, while the air flow rate that can be admitted by said engine 2 remains low. This exposes the takeoff compressor 42 to the risk of entering the pumping zone, that risk nevertheless being greatly lessened by the turbo supercharging device with air bleed and regeneration 1 according to the present invention.

In fact, the takeoff turbocharger 41 is reserved exclusively for supercharging of the alternating internal combustion heat engine 2 when the latter rotates at a low rating, for example up to one thousand five hundred or two thousand revolutions per minute. The takeoff turbocharger 41 is therefore specifically sized to provide a high supercharge at low ratings while offering the shortest possible response time, as is the case regarding supercharging systems with two two-stage turbochargers according to the state of the art, whereof the “high-pressure” turbocharger only supercharges the engines at a low rotation rating.

However, according to the state of the art, for said “high-pressure” compressor to escape pumping and operate as close as possible to its maximum output when the engine that it supercharges rotates at a very low rating, the load is swept through the combustion chamber of said engine so as to artificially increase the flow rate of said compressor. The sweeping in question is obtained using at least one camshaft phase shifter and, regarding gasoline engines, requires direct gasoline injection.

As an alternative to said load sweeping, the supercharging device 1 according to the invention provides that the flow rate of the takeoff compressor 42 is artificially increased not by sweeping of the load through said chamber, but by the passage of a fraction of said flow rate of said compressor 42 through the power compressor output valve 57. The compressor 42 thus escapes pumping through different means, has a larger size, and therefore has a better output, and can operate as close as possible to its maximum output.

In order for the takeoff turbine 45 to be able to drive the takeoff compressor 42 despite the additional work that must be provided by said turbine 45 caused by the fraction of the flow rate said compressor 42 passing through the power compressor output valve 57, a case has been provided in which said turbine 45 is housed that leaves a narrow passage between it and said turbine 45. Thus, the pressure of the exhaust gas is expelled from the alternating internal combustion heat engine 2 is increased such that the takeoff turbine 45 indeed produces said additional work, even though a significant part thereof is taken on the crankshaft 5 of said engine 2 via the combustion chamber 4 that must overcome an increased back pressure in the exhaust phase.

The driving of the takeoff compressor 42 is therefore expensive in terms of energy in return for good reactivity of said compressor 42 in order to quickly provide a high supercharging pressure to the alternating internal combustion heat engine 2.

However, the supercharging of said engine 2 using the takeoff turbocharger 41 is transitional. In fact, the fraction of the atmospheric air expelled by the takeoff compressor 42 and that passes through the power compressor output valve 57 quickly reaches the regenerating exchanger 31, and more specifically the regenerating heating channel 33. In the latter, said air is preheated at a temperature substantially lower than that of the exhaust gases immediately after they have been expelled by the alternating internal combustion heat engine 2, since in fact, said exhaust gases circulating in the opposite direction in the regenerating cooling channel 32 have been mixed with said atmospheric air at the junction for mixing the gases 53 after said air has passed through the power turbine 27, then has also joined said cooling channel 32 via said junction 53 after having been expelled by said turbine 27 via the upper duct of the power turbine 30. Said exhaust gases mixed with said atmospheric air and circulating in the regenerating cooling channel 32 emerge from the latter at a lower temperature, potentially close to that of the atmospheric air when it is expelled by the takeoff compressor 42.

Immediately after having been preheated by the mixture made up of exhaust gases mixed with the atmospheric air circulating in the regenerating cooling channel 32, the atmospheric air initially expelled by the takeoff compressor 42, then by the centrifugal power compressor 21 reaches the regenerating pre-exchanger 35, and more specifically the pre-exchanger heating channel 37. In the latter, said air is heated to a temperature substantially equal to that of the exhaust gases immediately after they have been expelled by the alternating internal combustion heat engine 2, since this time, said exhaust gases circulating in the opposite direction in the pre-exchanger cooling channel 36 have not been mixed.

Thus, in the two-stage exchanger 61, said exhaust gases have indeed transferred a large part of their heat to the atmospheric air having passed through the power compressor output valve 57.

When it goes into the two-stage exchanger 61, the atmospheric air expands greatly following the increase in temperature. Its flow rate and pressure increase, whereas it reaches the power turbine 27 via the intake duct of the power turbine 26. It is then expanded by said turbine 27, which produces work that it communicates to the centrifugal power compressor 21, which in return compresses the atmospheric air brought to it by the intake duct of the power compressor 19, with an increasing flow rate and pressure.

The power compressor output valve 57, which until now has been partially open, opens more and more, accompanying the increase in flow rate and pressure of the atmospheric air expelled at the output of the centrifugal power compressor 21, then it is the turn of the bleed valve of the power compressor 66 to be partially opened by the EMS management unit 6, such that the centrifugal power compressor 21 contributes to supercharging the alternating internal combustion heat engine 2.

In fact, when the bleed valve of the power compressor 66 becomes partially open, the opening of the power compressor output valve 57 being suitably adjusted, the pressure downstream from the takeoff direct blowing check valve 65 becomes greater than the pressure upstream of said valve 65. Said valve therefore remains closed. It will easily be understood, upon studying FIG. 5, that as a result of this configuration, the takeoff compressor 42 pre-compresses the atmospheric air in the direct blowing ducts of the takeoff compressor 64, while the centrifugal power compressor 21 pressurizes said air in the power compressor output duct 24, said air being conveyed in part toward the intake distributor 11 of the alternating internal combustion heat engine 2.

The power turbine 27 receiving an increasing mass and volume flow of atmospheric air to be expanded, its power gradually increases. Simultaneously, the air flow rate provided by the centrifugal power compressor 21 increases. The EMS management unit 6 can gradually open the takeoff turbine discharge valve 47 so as to gradually reduce the work produced by the takeoff turbine 45 and the contribution of the takeoff turbocharger 41 to the supercharging of the alternating internal combustion heat engine 2.

Beyond a certain air flow rate provided by the centrifugal power compressor 21, the EMS management unit 6 fully opens the takeoff compressor bypass valve 44 so that the takeoff compressor 42 ceases to supercharge the alternating internal combustion engine 2, the latter then only being supercharged by the power turbocharger 20, while said unit 6 also fully opens the takeoff turbine discharge valve 47, such that the takeoff turbine 45 ceases to drive the takeoff compressor 42.

It will be noted at this stage that the centrifugal power compressor 21 provides both atmospheric air intended to be heated in the two-stage exchanger 61 to provide the necessary energy to the power turbine 27, and at the same time—by bleeding via the bleed valve of the power compressor 66—the atmospheric air necessary for the supercharging of the alternating internal combustion heat engine 2, said air being cooled in the supercharging air cooler 10 before being suctioned by said motor 2 via the intake distributor 11.

As can easily be deduced from FIG. 5, used here to illustrate the operation of the device 1 according to the invention, the hot atmospheric air expanded by the power turbine 27 is next expelled by said turbine 27 in the output duct of the power turbine 30, then mixed at the junction for mixing gases 53 with the hot exhaust gases expelled by the alternating internal combustion heat engine 2. Next, during their circulation in the regenerating cooling channel 32, said air and said gases transfer a large portion of their heat to the atmospheric air expelled by the centrifugal power compressor 21, before said atmospheric air is lastly heated in the pre-exchanger heating channel 37.

Thus, the hot atmospheric air leaving the pre-exchanger heating channel 37 loses part of its heat when it is expanded by the power turbine 27, said heat being transformed into work by said turbine 27, then transfers—in the regenerating exchanger 31—a large part of its remaining heat to the atmospheric air expelled by the centrifugal power compressor 21. The heat regeneration constituted by the passage of said air in said exchanger 31 provides a large part of the heat energy necessary for the operation of the power turbine 27, while the additional heat energy necessary for the operation of the power turbocharger 20 is provided by the cooling of the exhaust gases expelled by the alternating internal combustion heat engine 2 in the regenerating exchanger 31 on the one hand and in the regenerating pre-exchanger 35 on the other hand, said exchanger 31 and said pre-exchanger 35 being assembled together in a single and same two-stage exchanger 61.

Thus, said engine 2 is supercharged without having to undergo the additional back pressure at the exhaust ordinarily generated by the turbocharger turbines according to the prior art, with the exception of startups from a stop or during certain transitional power operations that requires the temporary use of the takeoff turbocharger 41.

Consequently, due to the lack of additional back pressure, the turbo supercharging device with air bleed and regeneration 1 according to the invention allows—relative to the state of the art in accordance with what was stated in the preamble—better phasing of the combustion of gasoline engines and/or an increase in their displacement ratio. This is favorable to the output of said gasoline engines. Furthermore, said device 1 imparts, to any alternating internal combustion heat engine 2 equipped with it, an intake pressure greater than its exhaust pressure, which produces an additional positive and usable work on the crankshaft 5 of said engine 2, without additional fuel consumption.

It will be noted that at a same Actual Average Pressure, the alternating internal combustion heat engine 2 increases in rating, and the quantity of pressurized atmospheric air bled by said engine 2 at the centrifugal power compressor 21 increases. Consequently, the mass flow rate of said compressor 21 must increase, like the work that must be provided by the power turbine 27 to drive it. However, the increase in the bleeding is immediately accompanied by the increase in the available heat power for said turbine 27, said power being delivered to the exhaust of said engine 2 via the exhaust gases thereof.

It will be noted that the alternating internal combustion heat engine 2 being hot enough and operating at partial loads, i.e., without supercharging, the power turbocharger 20 can continue to use the heat energy delivered at the exhaust of said engine 2—as long as the temperature of the corresponding exhaust gases is sufficient—so that the centrifugal power compressor 21 delivers a flow rate and pressure that are as high as possible to the power turbine 27, which in turn drives the rotation of the compressor 21. This strategy makes it possible to keep the power turbocharger 20 as available as possible to relay the takeoff turbocharger 41 in load transition of the alternating internal combustion heat engine 2.

To that end, once the power turbocharger 20 has increased in flow rate and pressure on the occasion of a first load increase, when the alternating internal combustion heat engine 2 no longer requires supercharging, the EMS management unit 6 leaves the power compressor output valve 57 open, while it keeps the bleed valve of the power compressor 66 closed. Thus, the entire flow rate of atmospheric air delivered by the centrifugal power compressor 21 is reserved for driving the power turbine 27, like all of the heat recoverable by the two-stage exchanger 61 is reserved for heating of said atmospheric air before the latter is expanded by said turbine 27.

It will be noted in this respect that according to the configuration selected in FIGS. 5 and 6, adjusting the load of the alternating internal combustion heat engine 2 using the intake butterfly valve 9 has no impact on the atmospheric air flow rate that may be admitted by the centrifugal power compressor 21 via the direct blowing duct of the takeoff compressor 64 and/or the direct supply duct of the power compressor 62, and vice versa.

FIGS. 5 and 6 show the inter-compressor connecting duct valve 68 that may close off the inter-compressor connecting duct 67. Said valve 68 makes it possible to reserve—when it is kept closed—all of the atmospheric air flow rate delivered by the takeoff compressor 42 to the alternating internal combustion heat engine 2 inasmuch as the power turbocharger 20 is already established in terms of flow rate and pressure following a previous load increase. Thus, said valve 68 for example makes it possible to guarantee a sufficient heat energy at the exhaust of said engine 2 using the takeoff turbocharger 41 before opening the bleed valve of the power compressor 66, which avoids temporarily unbalancing the energy balance between the heat energy available at the exhaust of said engine 2 to drive the centrifugal power compressor 21 and the supercharged power bled by the bleed valve of the power compressor 66.

It will be noted that the turbo supercharging device with air bleed and regeneration 1 according to the invention, as shown in FIGS. 4 to 6, makes it possible to reduce the maximum temperature to which the takeoff turbine 45 is subjected, since the latter is only subject to low ratings of the alternating internal combustion heat engine 2, where the exhaust gases of said engine exit at a moderate temperature, including very high loads. This makes it possible to make said turbine 45 from less expensive materials.

It will further be noted that this advantage is also valid for the power turbine 27 as shown in FIGS. 1 to 6, since the temperature of the atmospheric air that it admits at its input is still lower than that of the exhaust gases expelled by the alternating internal combustion heat engine 2, the temperature of said gases already being lower—due to the lack of significant back pressure at the exhaust—than that ordinarily found on supercharged gasoline engines operating at a comparable rating and load according to the state of the art. It will be noted that it is in particular possible to limit the power turbine 27 input temperature by providing a mass flow rate of atmospheric air admitted by said turbine 27 that is always higher than that selected for the air admitted by said engine 2 via the intake distributor 11. In that case, the air bleed rate at the centrifugal power compressor 21 to supercharge the alternating internal combustion heat engine 2 always remains below fifty percent, irrespective of the load of said engine 2.

Added to this is that—aside from the fact that the regenerating exchanger 31 cannot have a one hundred percent efficiency—the power turbine 27 transforms part of the heat from the exhaust gases expelled by said engine 2 into work. This causes the average temperature of the atmospheric air circulating in the regenerating loop formed by the turbo supercharging device with air bleed and regeneration 1 according to the invention to drop, for example using the two-stage exchanger 61.

Ultimately, the turbo supercharging device with air bleed and regeneration 1 according to the invention offers various levers for sizing and adjusting to achieve the best possible compromise between the input temperature of the power turbine 27, which in particular depends on the air bleed rate at the centrifugal power compressor 21, the output of the power turbocharger 20 in particular resulting from said temperature, and the output of the two-stage exchanger 61.

It will also be noted that in the context of the device 1 according to the invention, the power turbocharger 20 is not particularly subject to air pulses present at the intake and exhaust of the alternating internal combustion heat engine 2. Said pulses are in fact proportional to the air bleed rate, which can never exceed fifty percent, and are highly filtered by the inner volume of the ducts 24, 26, 30 and channels 32, 33, 36, 37 that connect the centrifugal power compressor 21 to the power turbine 27.

Upon analyzing FIGS. 4 to 6, it will be understood that the device 1 according to the invention makes it possible to produce a turbo supercharging system with two stages having only one turbine at the exhaust of the alternating internal combustion heat engine 2, in this case, the takeoff turbine 45. This in particular resolves the problem of the excessively long temperature increase time of the pollutant post-treatment catalysts related to the two-stage turbo supercharging according to the prior art. In fact, when two turbines follow one another at the exhaust of an alternating internal combustion heat engine, said turbines are heated as a priority by the exhaust gases expelled by said engine and the catalyst that is positioned after the last turbine no longer receives enough heat to reach its operational temperature in the requisite timeframe. This problem results in a great difficulty, or even impossibility, of remaining below maximum pollutant emission thresholds imposed by regulations. This problem is resolved by the device 1 according to the invention.

It can easily be deduced from FIGS. 1 to 6 that the sizing and design of the power turbocharger 20 are greatly facilitated relative to the prior art by the device 1 according to the invention, since aside from the advantage of the temperature reduction previously described, the moment of inertia of said turbocharger 20 has little impact on the dynamism and brilliance of the vehicles designed to receive said device 1, particularly if the configurations shown in FIGS. 5 and 6 are selected, which offer the broadest possibilities in terms of adjustments and optimizations.

In fact, the maintenance in terms of pressure and rating of the power turbocharger 20 make the latter continuously available to relay the takeoff turbocharger 41 without having to restart the rotation of said turbocharger 20 from a low rating. As a result, said turbocharger 20 can have a significant moment of inertia without the kinematic losses it can cause in load transition of the alternating internal combustion heat engine 2 being significantly increased. This facilitates the sizing and design of said turbocharger 20 in order to obtain a higher efficiency at a lower cost therefrom.

In light of the above, the wheel of the centrifugal power compressor 21 can be made from a material with high resistance to abrasion and cavitation, such a material being heavier by reputation. This strategy in particular makes it possible to admit recirculated exhaust gases at the input of said compressor 21, even if said gases convey condensation water droplets formed during cooling of said gases, the latter being able to be admitted for example via the recirculation duct for the exhaust gases 58 as shown in FIGS. 4 to 6, said duct 58 comprising a cooler for the recirculated exhaust gases 60 and a recirculation valve for the exhaust gases 59.

Furthermore, the turbo supercharging device with air bleed and regeneration 1 according to the invention potentially makes it possible to provide large quantities of recirculated exhaust gases to the alternating internal combustion heat engine 2 that it supercharges, which is an additional factor improving the efficiency of said engine 2.

In fact, according to the state of the art, the power and the efficiency of the supercharging limits the recirculated exhaust gas levels of high loads, particularly in the case of gasoline engines. This is due to the fact that said gases do not participate in the combustion and compressing them consumes energy. Thus, beyond a certain level of recirculated exhaust gases, the benefit in terms of thermodynamic efficiency procured by said gases becomes lower than the energy cost related to the compression thereof.

The turbo supercharging device with air bleed and regeneration 1 according to the invention resolves this problem in large part inasmuch as the power turbocharger 20 has considerable energy—owing to the regeneration—to compress a mixture of atmospheric air and recirculated exhaust gases in the intake distributor 11. The additional energy used by the power turbine compressor 20 is ordinarily lost in the case of alternating internal combustion heat engines according to the state of the art.

In this context, it is advantageous to increase the recirculated exhaust gas level at high loads as much as possible, which results in increasing the intake pressure of the alternating internal combustion heat engine 2, since said increase produces excess positive work usable on the crankshaft 5 of said engine 2, without additional fuel consumption.

Thus, the recirculation of the exhaust gases done by the device 1 according to the invention makes it possible—aside from reducing the sensitivity to pinking and the heat losses of gasoline engines—to recover more heat energy at the exhaust of the alternating internal combustion engine 2, said energy being converted into available work on the crankshaft 5 by means of the power turbine 27, which drives the centrifugal power compressor 21, which compresses a mixture of atmospheric air and recirculated exhaust gases at the intake of said engine 2 via the intake distributor 11, said mixture pushing the combustion piston 4, which produces said work on the crankshaft 5.

Another method of using the excess energy available to the power turbocharger 20, and more particularly the power turbine 27, consists of supercharging the alternating internal combustion heat engine 2 more than necessary in order to use the positive work that may be produced by the intake gases compressed by the centrifugal power compressor 21 on the combustion piston 4 of said engine 2. This is done by voluntarily reducing the volumetric efficiency of said engine 2, in particular by adjusting the timing diagram of said engine 2 so that the latter performs a so-called “Miller” cycle. In that case, said engine 2 discharges the excess part of the intake gases in the intake distributor 11 through its intake valve(s), but part of the positive work produced by said gases on the combustion piston 4 remains, which contributes to producing more work on the crankshaft 5, and therefore reducing the consumption of said engine 2.

It will be noted that in FIGS. 1 to 6, the pollutant post-treatment catalyst 13 is always placed before the regenerating exchanger 31, and possibly before the regenerating pre-exchanger 35. This configuration in particular makes it possible to recover the heat given off by the exothermic combustion of the pollutants in said catalyst 13 to increase, via the regenerating exchanger 31 to which the regenerating pre-exchanger 35 is possibly added, the energy available for the power turbine 27.

It will be noted that in order to protect the pollutant post-treatment catalyst 13 from any excessive temperatures, it may be provided that the regenerating pre-exchanger 35 is positioned—relative to the circulation direction of the exhaust gases expelled by the alternating internal combustion heat engine 2—before said catalyst 13. This configuration, shown in FIG. 3, has the interest of substantially reducing the temperature of the exhaust gases before they pass through said catalyst 13.

Another strategy that can be combined with the previous one consists of operating the alternating internal combustion heat engine 2 with excess fuel, which allows it to deliver more power per quantity of atmospheric air admitted at the intake distributor 11, while the pollutants inevitably produced by such an operation are burned, at stoichiometry, in the pollutant post-treatment catalyst 13 via the contribution of the strictly necessary quantity of atmospheric air upstream from said catalyst 13 via the supercharging air bleed duct 55 shown in FIGS. 1 and 2, said contribution being monitored by the EMS management unit 6 using the supercharging air bleed valve 56.

It must be understood that the preceding description has only been provided as an example and in no way limits the scope of the invention; it would not be outside the scope of the invention to replace the described embodiment details with any equivalent means.

1. A turbo supercharging device with air bleed and regeneration (1), provided for an alternating internal combustion heat engine (2) that comprises at least one combustion cylinder (3), at least one combustion piston (4) connected to at least one crankshaft (5), at least one intake air filter (7) comprising an input connected to an intake input of the engine (51) and an output connected to an intake distributor (11) via an intake duct of the heat engine (8), via an intake distributor input duct (52) and via an intake butterfly valve (9), said engine (2) also comprising at least one exhaust line (14) that begins with an exhaust manifold (12) extended by an exhaust manifold output duct (54) that includes a pollutant post-treatment catalyst (13), said line (14) also comprising an exhaust muffler (15) and ending with an exhaust line output (16), while said engine (2) is controlled by at least one EMS management unit (6), characterized in that it comprises:
At least one regenerating exchanger (31) that includes at least one regenerating cooling channel (32) in which in particular exhaust gases expelled by the alternating internal combustion engine (2) via the exhaust manifold output duct (54) can circulate, said gases being able to cool in contact with the inner walls of said cooling channel (32) before reaching the exhaust line output (16), said exchanger (31) also including at least one regenerating heating channel (33) in which other gases can circulate that can heat in contact with the inner walls of said heating channel (33), while the gases that can circulate in the regenerating cooling channel (32) can transfer their heat to the other gases that can circulate in the regenerating heating channel (33);
at least one power turbocharger (20) that includes at least one centrifugal power compressor (21) able to compress the other gases, said compressor including an input at least connected to the intake input of the engine (51) via an intake duct of the power compressor (19), while it includes an output that can be connected either to the intake distributor (11) via the intake distributor input duct (52), or to the regenerating heating channel (33), or to both, via at least one power compressor output duct (24);
at least one power turbine (27) included by the power turbocharger (20) and that can expand the other gases to rotate the centrifugal power compressor (21), said turbine (27) including an input connected to the power compressor output duct (24) via the regenerating heating channel (33), then via an input duct of the power turbine (26) inserted between said channel (33) and said input, while said turbine (27) includes an output directly or indirectly connected to the exhaust line output (16) via an output duct of the power turbine (30).

2. The turbo supercharging device with air bleed and regeneration according to claim 1, characterized in that the exhaust gases expelled by the alternating internal combustion heat engine (2) via the exhaust manifold output duct (54) that are mixed before being introduced into the regenerating cooling channel (32) at a junction (53) for mixing gases with the other gases expelled by the power turbine (27) via the output duct of the power turbine (30), the exhaust gases and said other gases circulating together in said cooling channel (32) before reaching the exhaust line output (16).

3. The turbo supercharging device with air bleed and regeneration according to claim 1, characterized in that the gases, in particular exhaust gases, that circulate in the regenerating cooling channel (32) move in the approximate opposite direction from that in which the other gases that circulate in the regenerating heating channel (33) move, while a material with a certain thickness for which one of the faces forms all or part of the inner walls of said cooling channel (32) also forms, on its opposite face, all or part of the inner walls of said heating channel (33), or vice versa.

4. The turbo supercharging device with air bleed and regeneration according to claim 1, characterized in that the intake distributor input duct (52) includes a supercharging air cooler (10).

5. The turbo supercharging device with air bleed and regeneration according to claim 1, characterized in that the power compressor output duct (24) includes a power compressor output check valve (25) allowing the gases circulating in said duct (24) to leave the centrifugal power compressor (21), but not to return to it.

6. The turbo supercharging device with air bleed and regeneration according to claim 1, characterized in that the power compressor output duct (24) includes a power compressor output valve (57) that can connect the output of the centrifugal power compressor (21) with the intake duct of the power turbine (26).

7. The turbo supercharging device with air bleed and regeneration according to claim 1, characterized in that the power compressor output duct (24) includes a power compressor bleed valve (66) that can connect the output duct (24) with the intake duct of the power turbine (52).

8. The turbo supercharging device with air bleed and regeneration according to claim 1, characterized in that the power compressor intake duct (19) and the power compressor output duct (24) are connected to each other by a bypass duct of the power compressor (22) that can be closed off by a bypass valve of the power compressor (23).

9. The turbo supercharging device with air bleed and regeneration according to claim 7, characterized in that the bypass duct of the power compressor (22) includes a priming centrifugal compressor (39).

10. The turbo supercharging device with air bleed and regeneration according to claim 1, characterized in that the intake duct of the power turbine (26) and the output duct of the power turbine (30) that are connected to each other by a discharge duct of the power turbine (28) that can be closed off by a discharge valve of the power turbine (29).

11. The turbo supercharging device with air bleed and regeneration according to claim 9, characterized in that the discharge duct of the power turbine (28) comprises at least one power trimming drive turbine (48).

12. The turbo supercharging device with air bleed and regeneration according to claim 1, characterized in that the power compressor output duct (24) and an exhaust manifold output duct (54) are connected to each other by a supercharging air bleed duct (55) that can be closed off by a supercharging air bleed valve (56).

13. The turbo supercharging device with air bleed and regeneration according to claim 2, characterized in that a part of the intake duct of the power turbine (26) constitutes part of a regenerating pre-exchanger (35) by forming at least one pre-exchanger heating channel (37) in which the other gases can circulate after the latter have been expelled by the centrifugal power compressor (21), then are heated in contact with the inner walls of the regenerating heating channel (33), said pre-exchanger (35) also including at least one pre-exchanger cooling channel (36) that forms part of the exhaust manifold output duct (54) and in which the exhaust gases expelled by the alternating internal combustion heat engine (2) can circulate, the latter gases being able to cool in contact with the inner walls of said cooling channel (36) by transferring their heat to the other gases expelled by the centrifugal power compressor (21).

14. The turbo supercharging device with air bleed and regeneration according to claim 13, characterized in that the regenerating pre-exchanger (35) and the regenerating exchanger (31) are alongside one another to jointly form a two-stage exchanger (61) including at least five exchanger orifices (69).

15. The turbo supercharging device with air bleed and regeneration according to claim 1, characterized in that part of the power compressor output duct (24) constitutes part of a regenerating post-exchanger (70) by forming at least one post-exchanger heating channel (72) in which the other gases can circulate after they have been expelled by the centrifugal power compressor (21) and before the latter circulate in the regenerating heating channel (33), said post-exchanger (70) also including at least one post-exchanger cooling channel (71) that forms part of the output duct of the power turbine (30) and in which said other gases can circulate after the latter have been expelled by the power turbine (27), said other gases being able to cool in contact with the inner walls of said cooling channel (71) by transferring their heat to said other gases expelled by the centrifugal power compressor (21).

16. The turbo supercharging device with air bleed and regeneration according to claim 15, characterized in that the regenerating post-exchanger (70) and the regenerating exchanger (31) are alongside one another to jointly form a two-stage exchanger (61) including at least six exchanger orifices (69).

17. The turbo supercharging device with air bleed and regeneration according to claim 1, characterized in that the power compressor output duct (24) and/or an intake duct of the power turbine (26) can include a supercharging pressure reservoir (38).

18. The turbo supercharging device with air bleed and regeneration according to claim 1, characterized in that the intake duct of the heat engine (8) comprises at least one takeoff compressor (42).

19. The turbo supercharging device with air bleed and regeneration according to claim 18, characterized in that the intake duct of the power compressor (19) is connected to the intake input of the engine (51) by a direct supply duct of the power compressor (62) that bypasses the takeoff compressor (42).

20. The turbo supercharging device with air bleed and regeneration according to claim 19, characterized in that the direct supply duct of the power compressor (62) includes a direct supply power check valve (63) allowing the gases circulating in said duct (62) to go from the intake input of the engine (51) toward the intake duct of the power compressor (19), but not the reverse.

21. The turbo supercharging device with air bleed and regeneration according to claim 18, characterized in that the takeoff compressor (42) comprises an output that is connected to the intake distributor input duct (52) by a direct blowing duct of the takeoff compressor (64) independent from the direct supply duct of the power compressor (62).

22. The turbo supercharging device with air bleed and regeneration according to claim 21, characterized in that the direct blowing duct of the takeoff compressor (64) includes a direct blowing takeoff check valve (65) allowing the gases circulating in said duct (64) to go from the takeoff compressor (42) toward the intake distributor input duct (52), but not the reverse.

23. The turbo supercharging device with air bleed and regeneration according to claim 21, characterized in that the direct blowing duct of the takeoff compressor (64) that is connected to the direct supply duct of the power compressor (62) by an inter-compressor connecting duct (67) that can be closed off by an inter-compressor connecting duct valve (68).

24. The turbo supercharging device with air bleed and regeneration according to claim 18, characterized in that the takeoff compressor (42) can be rotated by at least one takeoff turbine (45) positioned on the exhaust manifold output duct (54).

25. The turbo supercharging device with air bleed and regeneration according to claim 18, characterized in that the takeoff compressor (42) that comprises an input and an output connected to each other by a takeoff compressor bypass duct (43) that can be closed off by a takeoff compressor bypass valve (44).

26. The turbo supercharging device with air bleed and regeneration according to claim 24, characterized in that the takeoff turbine (45) comprises an input and an output connected to each other by a takeoff turbine discharge duct (46) that can be closed off by a takeoff turbine discharge valve (47).

27. The turbo supercharging device with air bleed and regeneration according to claim 1, characterized in that the input duct of the power compressor (19) and an input duct of the intake distributor (52) are connected to each other by a direct intake duct (17) that can be closed off by a direct intake valve (18).

28. The turbo supercharging device with air bleed and regeneration according to claim 1, characterized in that the intake duct of the heat engine (8) and/or the intake duct of the power compressor (19) is (are) connected to the exhaust line (14) by an exhaust gas recirculation duct (58) that can be closed off by an exhaust gas recirculation valve (59).

29. The turbo supercharging device with air bleed and regeneration according to claim 28, characterized in that the exhaust gas recirculation duct (58) includes a recirculated exhaust gas cooler (60).

30. The turbo supercharging device with air bleed and regeneration according to claim 1, characterized in that all or part of the outer and/or inner surface of the power compressor output duct (24) and/or the intake duct of the power compressor (26) and/or the regenerating exchanger (31) and/or the regenerating pre-exchanger (35) and/or and/or the exhaust manifold (12) and/or the exhaust manifold output duct (54) and/or the exhaust line (14) bears a heat screen (50).
